(19) United States
(12) Patent Application Publication
(10) Pub. No.: US 2011/0272231 A1
(43) Pub. Date: Nov. 10, 2011

(54) ARTICLES OF MANUFACTURE THAT ARE ADJUSTABLE IN SIZE

(76) Inventors: Barry Hoberman, Coral Springs, FL (US); Robin Rankin, Toronto (CA)

(21) Appl. No.: 12/867,903

(22) PCT Filed: Feb. 3, 2010
(86) PCT No.: PCT/US10/22972

§ 371 Date: Jun. 15, 2011

(30) Foreign Application Priority Data
Feb. 3, 2009 (CA) 2652174

(51) Int. Cl. A45C 7/00; B23P 23/00

(52) U.S. Cl. 190/103; 29/401.1

(57) ABSTRACT

Systems (102) and methods (600) for adjusting a volume of an article of manufacture (AOM). The methods involve displacing a first actuator (FA) in a first direction along tracks (308, 310) until FA (312) disengages a first track (308) and abuts a first stop mechanism (504) formed at an end (510) ofa second track (310). A first flexible insert (FFI) is unfolded so as to adjust the volume of AOM by a first amount defined by geometrical dimensions of FFI (306). A second actuator (SA) is displaced in a second direction along tracks until SA (424) abuts a second stop mechanism (432) formed at ends (454) of the tracks (420, 422). A second flexible insert (SFI) is unfolded so as to further adjust the volume of AOM by a second amount defined by geometrical dimensions of SFI (406).

### CROSS REFERENCE TO RELATED APPLICATIONS

This applications claims priority to Canadian Patent Application No. 2,642,174 filed Feb. 3, 2009. The entire disclosure is incorporated by reference herein.

### BACKGROUND OF THE INVENTION

1. Statement of the Technical Field

The inventive arrangements relate to articles of manufacture (e.g., garments and bags), and more particularly to articles of manufacture that are adjustable in size.

2. Description of the Related Art

There are various conventional multi-stage expandable-contractible systems known in the art for providing expansion and contraction capabilities to bags and garments. The bags include, but are not limited to, luggage bags, duffle bags, sports bags, purses, backpacks, brief cases and hand carried bags. The garments include, but are not limited to, shirts, pants, jackets and sweaters.

Such a conventional multi-stage expandable-contractible system generally includes an inset element that extends circumferentially around a bag, a sleeve or a pant leg. The inset element includes a single slide fastener configured to provide two or more successive stages of expansion and contraction. In this regard, the slide fastener comprises a zipper element having a three dimensional multi-turn spiral configuration. During use, the expandable inset element is selectively expanded and contracted in a multi-stage fashion by displacing an actuator (or zipper slider) of the zipper element one or more spiral turns at any given time. For example, the expandable inset element is transitioned from a contracted position to a first stage expanded position by displacing the actuator once about a periphery of the bag, sleeve or pant leg. Similarly, the expandable inset element is transitioned from a contracted position to a second stage expanded position by displacing the actuator twice about the periphery of the bag, sleeve or pant leg.

Despite the advantages of the conventional multi-stage expandable-contractible system discussed above, it suffers from certain drawbacks. For example, the spiral zipper element of the conventional multi-stage expandable-contractible system can not be used in two (2) dimensional applications. Also, the expandable inset element can not be simultaneously placed in a first stage partially expanded position and a second stage partially expanded position. Further, the conventional multi-stage expandable-contractible system can not be assembled in a fully automated process. As such, a bag or garment employing the conventional multi-stage expandable-contractible system is relatively expensive to manufacture.

### SUMMARY OF THE INVENTION

Embodiments of the present invention concern methods for adjusting a volume of an article of manufacture having an expandable-contractible system. The methods generally involve displacing a first actuator in a first direction along first tracks coupled to the article of manufacture. The first actuator can be displaced along the first tracks until it (a) disengages a first one of the first tracks and (b) abuts a first stop mechanism formed at a first end of a second one of the first tracks. The first stop mechanism can be formed by: attaching a grommet to the first end of the second one of the first tracks; or bending the first end of the second one of the first tracks. The first tracks can have a rectilinear shape or a curvilinear shape.

The methods also involve unfolding a first flexible insert so as to adjust the volume of the article of manufacture by a first amount. The first amount can be defined by the geometrical dimensions of the first flexible insert. The first flexible insert is coupled to at least the first one of the first tracks.

The methods further involve displacing a second actuator in a second direction along second tracks coupled to the article of manufacture. The second actuator can be displaced in a second direction along the second tracks until it abuts a second stop mechanism formed at first ends of the second tracks. The second tracks can have a rectilinear shape or a curvilinear shape. The second stop mechanism can be formed by joining the first ends of the second tracks together. The second direction can be the same as or different than the first direction. Notably, the second actuator and the second tracks are concealed in the article of manufacture when the expandable-contractible system is not in use.

A second flexible insert is unfolded so as to further adjust the volume of the article of manufacture by a second amount defined by geometrical dimensions of the second flexible insert. The second flexible insert is coupled to the second tracks. The second amount can be greater than, equal to or less than the first amount.

The volume of the article of manufacture can be decreased by folding the first flexible insert and displacing the first actuator in a third direction opposed from the first direction alone the first tracks. The volume of the article of manufacture can also be decreased by folding the second flexible insert and displacing the second actuator in a fourth direction opposed from the second direction along the second tracks.

Embodiments of the present invention also concern expandable-contractible systems implementing the above described methods for adjusting a size of an article of manufacture. Each of the expandable-contractible systems comprises at least two first tracks having non-spiral shapes, at least two second tracks having non-spiral shapes, a first actuator, a first flexible insert, a second actuator and a second flexible insert. The second tracks are disposed in the expandable-contractible system so as to be concealed at least partially by the first tracks when the expandable-contractible system is not in use. The first actuator is configured for being displaced in a first direction along the first tracks. The first actuator is also configured for being disengaged from a first one of the first tracks. The first flexible insert is configured to be transitioned from a folded position to an unfolded position in which the size of the article of manufacture is increased by a first amount defined by geometrical dimensions of the first flexible insert. The second actuator is configured for being displaced in a second direction along the second tracks. The second flexible insert is configured to he transitioned from a folded position to an unfolded position in which the size of the article of manufacture is increased by a second amount defined by geometrical dimensions of the second flexible insert.

Embodiments of the present invention further concern expandable-contractible systems for adjusting an overall size of an article of manufacture. Each of the expandable-contractible systems comprises first and second closure elements. The first closure element is of first type of closure element. The second closure element is of a second type or closure element. The first type of closure element is different from the second type of closure element. For example, the first type of closure element includes, but is not limited to, a zipper assembly. In contrast, the second type of closure element includes, but is not limited to, a velcro closure element, a loop-and-pile fastener assembly, a snap assembly, a button/hole pair assembly and a latch assembly.

Embodiments of the present invention further concerns bags having the same or substantially similar types of closure elements. Each of the bags includes at least one compartment structure defining an interior space for carrying articles. The bag also includes an expandable-contractible system configured for adjusting a size of the interior space. The expandable-contractible system comprises at least two first tracks having non-spiral shapes, at least two second tracks having non-spiral shapes, a first actuator, a first flexible insert, a second actuator and a second flexible insert. The second tracks are disposed in the expandable-contractible system so as to be concealed at least partially by the first tracks when the expandable-contractible system is not in use. The first actuator is configured for being displaced in a first direction along the first tracks. The first actuator is also configured for being disengaged from a first one of the first tracks. The first flexible insert is configured to he transitioned from a folded position to an unfolded position in which the size of the interior space is increased by a first amount defined by geometrical dimensions of the first flexible insert. The second actuator is configured for being displaced in a second direction along the second tracks. The second flexible insert is configured to be transitioned from a folded position to an unfolded position in which the size of the interior space is increased by a second amount defined by geometrical dimensions of the second flexible insert.

Embodiments of the present invention also concerns bag comprising different types of closure elements. Each of the bags includes at least one compartment structure defining an interior space for carrying articles. The bag also includes an expandable-contractible system for adjusting an overall size of the bag. The expandable-contractible system comprises first and second closure elements. The first closure element is of a first type of closure element. The second closure element is of a second type of closure element. The first type of closure element is different from the second type of closure element. For example, the first type of closure element includes, but is not limited to, a zipper assembly. In contrast, the second type of closure element includes, but is not limited to, a velcro closure element, a loop-and-pile fastener assembly, a snap assembly, a button/hole pair assembly and a latch assembly.

### BRIEF DESCRIPTION OF THE DRAWINGS

Embodiments of the present invention will be described with reference to the following drawing figures, in which like numerals represent like items throughout the figures and in which:

FIG. 1 is a perspective view of an exemplary article of manufacture comprising a multi-stage expandable-contractible system that is useful for understanding the present invention.

FIG. 2 is a perspective view of the bag of FIG. 1 having a primary compartment structure in a partially opened position that is useful for understanding the present invention.

FIG. 3 is a perspective view of the bag of FIG. 1 in a first stage expanded position that is useful for understanding the present invention.

FIG. 4 is a perspective view of the bag of FIG. 1 in a second stage expanded position that is useful for understanding the present invention.

FIG. 5 is an exploded view of the multi-stage expandable-contractible system shown in FIG. 1 that is useful for understanding the present invention.

FIG. 6 is a flow diagram of an exemplary method for adjusting a volume of an article of manufacture that is useful for understanding the present invention.

### DETAILED DESCRIPTION

The present invention is described with reference to the attached figures, wherein like reference numbers are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The present invention generally concerns multi-stage expandable-contractible systems that can he used in a variety of applications. Such applications include, but are not limited to, bag applications and clothing applications. The multi-stage expandable-contractible system generally comprises a plurality of inset elements configured to provide two or more stages of expansion and contraction.

Notably, the present invention overcomes various drawbacks of conventional multi-stage expandable-contractible systems. For example, the multi-stage expandable-contractible system of the present invention can be used in two (2) dimensional applications. As such, the multi-stage expandable-contractible system can be integrated along a length of a shirt sleeve, a pant leg, and a panel of a bag. Also, the multi-stage expandable-contractible system can be simultaneously placed in a first stage partially expanded position and a second stage partially expanded position. The multi-stage expandable-contractible system can further be implemented during a fully automated process. As such, an article employing the present invention is less expensive to manufacture as compared to articles comprising conventional multi-stage expandable-contractible systems.

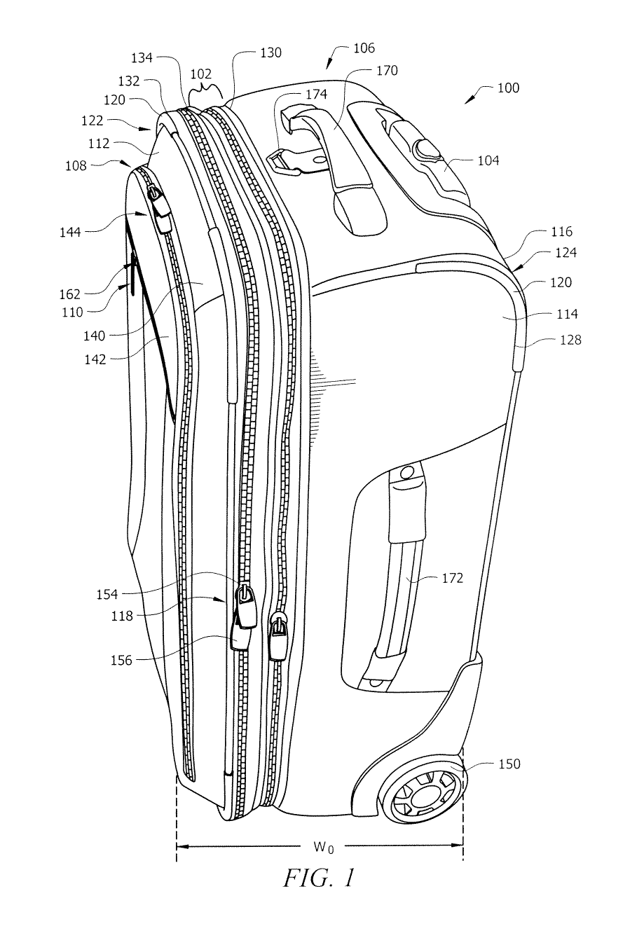

The present invention will now be described in more detail in relation to FIGS. 1-5. Although the present invention will be described in relation to a bag, the present invention is not limited in this regard. For example, the present invention can also be used with other articles of manufacture, such clothing (e.g., shirts, pants, gloves and boots).

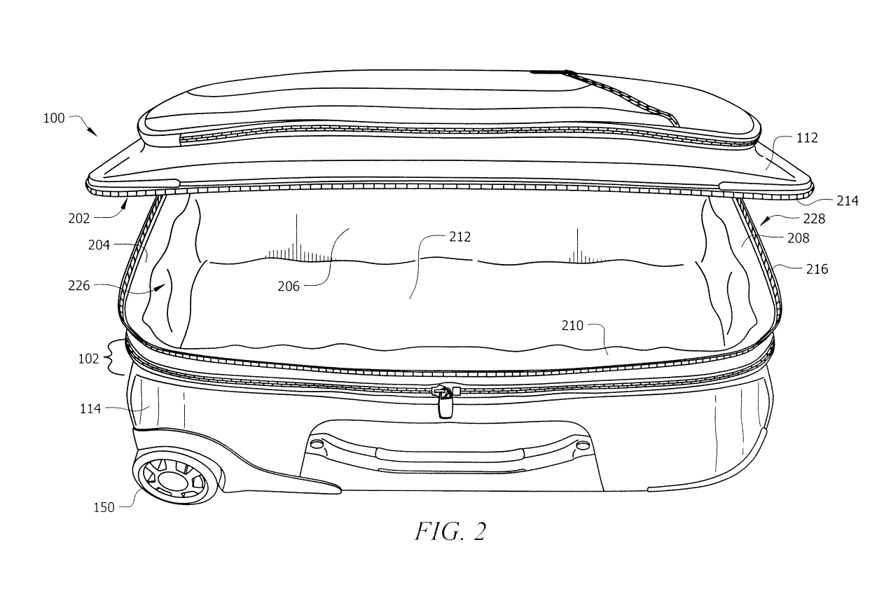

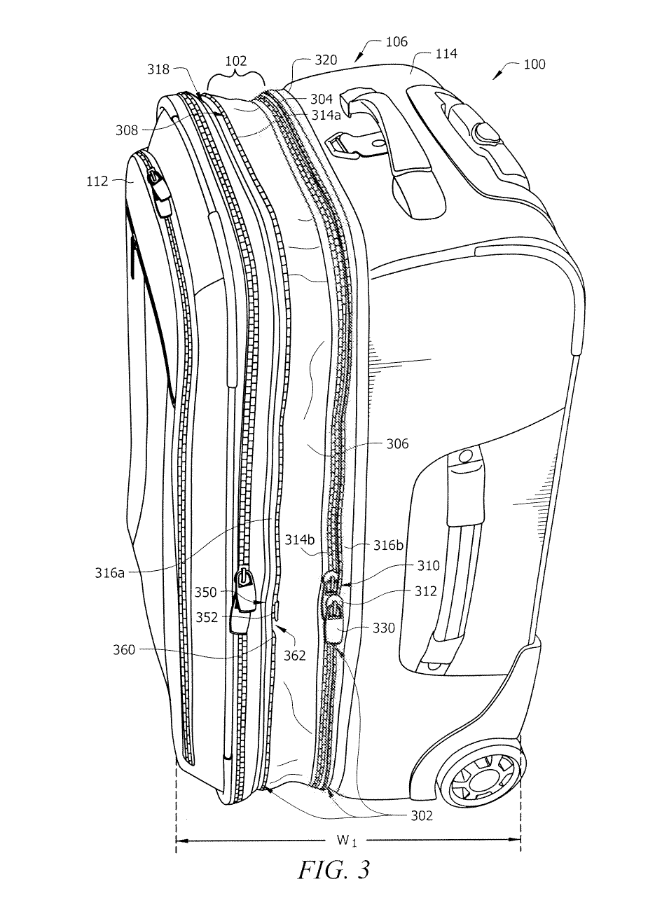

In FIG. 1, there is provided a perspective view ofan exemplary bag 100 in a closed position. A perspective view of the bag 100 in a partially opened position is provided in FIG. 2. Notably, the bag 100 comprises a multi-stage expandable-contractible system 102. The multi-stage expansion/contraction system 102 is generally configured to facilitate the expansion and contraction of the bag 100. The multi-stage expandable-contractible system 102 will be described in detail below in relation to FIGS. 3-5.

As shown in FIGS. 1-2, the bag 100 includes wheeled luggage comprising wheels 150 and an extendable handle 104 that allow for convenient maneuverability thereof. Embodiments of the present invention are not limited in this regard. For example, the bag 100 can alternatively include a backpack, a purse, a garment bag, a sports bag, a travel bag, a duffle bag, a backpack or a carry-on bag.

As also shown in FIGS. 1-2, the bag 100 includes a primary compartment structure 106 and a plurality of secondary compartment structures 108, 110 for carrying articles. Such articles include, but are not limited to, cloths, shoes, towels, toys, fluid/liquid products, books, school supplies, toiletries, makeup and other items. The primary and secondary compartment structures 106, 108, 110 can be formed from any suitable material. Such materials include, but are not limited to, non-woven materials, woven materials, mesh materials, water-resistant materials, leather, canvas, collapsible fabric materials, fabric materials impregnated with plastic, and fabric materials impregnated with a rubberized material. Notably, each of the compartment structures 106, 108, 110 can be formed from the same material or different material(s). The material(s) forming the compartment structures 106, 108, 110 can have a design or pattern printed thereon so as to provide an ornamental or decorative appearance to the bag 100.

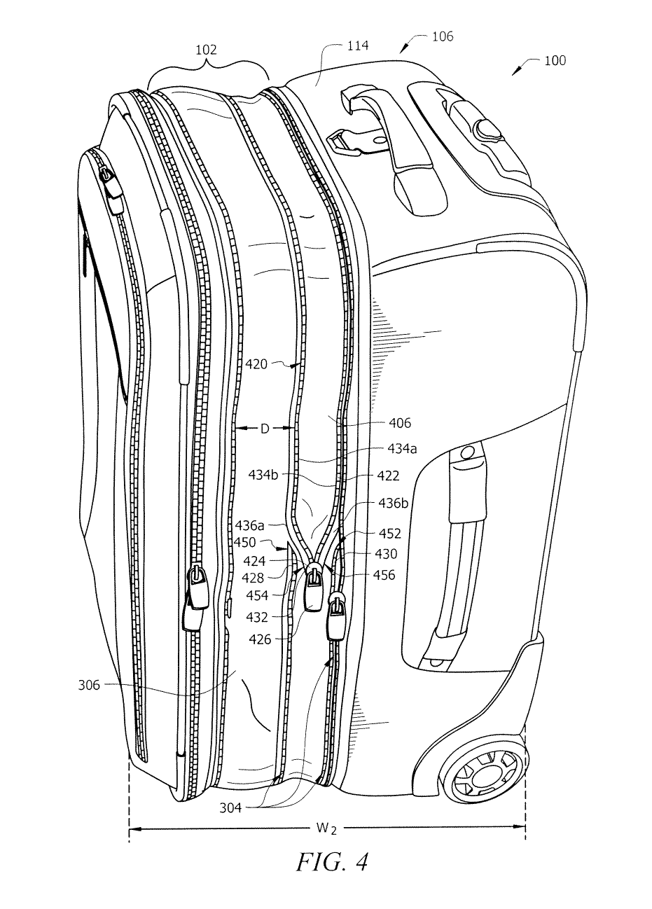

Notably, the primary compartment structure 106 is joined to the secondary compartment structure 108 by the multi-stage expandable-contractible system 102. Consequently, the primary compartment structure 106 is movable with respect to the secondary compartment structure 108 such that the bag 100 is adjustable between a contracted position (shown in FIG. 1) and a plurality of expanded positions (shown in FIGS. 3-4). The multi-stage expandable-contractible system 102 will be described in detail below.

Although two (2) secondary compartment structures are shown in FIGS. embodiments of the present invention are not limited in this regard. The bag 100 can include more or less secondary compartment structures than those shown in FIGS. 1-2. For example, the bag 100 can include at least one secondary compartment structure 108, 110 disposed on a front panel 112 of the primary compartment structure 106 (as shown in FIGS. 1-2) and at least one secondary compartment structure disposed on a sidewall 114 of the primary compartment structure 106 (not shown in FIGS. 1-2). Secondary compartment structures can also be provided inside the bag 100 (not shown in FIGS. 1-2). In this scenario, the secondary compartment structures can be coupled to inner surfaces 202, 204, 206, 208, 210, 212 of the panels 112, 116 and/or sidewalls 114 of the bag 100.

The primary compartment structure 106 may be considered the primary article-carrying compartment structure because it provides the largest unrestricted volume for carrying articles. If only the primary compartment structure 106 is desired to be used, then one would only need to open the primary compartment structure 106 via a closure element 118. This configuration is ideal for carrying articles which require the volume of the primary compartment structure 106. Such articles can include, but are not limited to, electronic equipment, clothing, books, sports equipment, retractable umbrellas, and thermoses.

As shown in FIGS. 1-2, the primary compartment structure 106 has a front panel 112 defining a first bag opening 228 which is selectively closable via the closure element 118. The closure element 118 can include, but is not limited to, a zipper assembly (shown in FIGS. 1-2), a velcro closure element, loop-and-pile fasteners, snaps, button/hole pairs and latches. The closure element 118 extends around at least a portion of a periphery of the bag 100. If the closure element 118 includes a zipper assembly, then it includes a first track 214, a second track 216 and at least one actuator 154, 156. In this scenario, the tracks 214, 216 include sets of teeth and the actuator 154, 156 includes a zipper slider. A portion of the first track 214 is coupled to the front panel 112 of the primary compartment structure 106. A portion of the second track 216 is coupled to the multi-stage expandable-contractible system 102. The actuator 154, 156 is coupled to the tracks 214, 216 so as to facilitate the separation and joinment thereof. For example, the tracks 214, 216 are separated and joined by moving the actuator(s) 154, 156 around at least a portion of the periphery of the bag 100. Notably, the actuator(s) 154, 156 is(are) unable to be detached or disengaged from the tracks 214, 216. The tracks 214, 216 and actuator(s) 154, 156 can be formed from plastic or metal.

The primary compartment structure 110 also includes the back panel 116 and at least one sidewall 114 which extends between the front panel 112 and the back panel 116. At least one of the panels 112, 116 and sidewalk 114 is formed of a rigid or semi-rigid material suitable to maintain its shape and structural integrity during use of the bag 100. Alternatively, at least one of the panels 112, 116 and sidewalls 114 includes a rigid or semi-rigid insert. A ribbing or tubing 120 can be utilized to provide additional stability and rigidity to the bag 100. The ribbing or tubing 120 can be disposed around peripheral edges 122, 124 of at least one of the panels 112, 116 and/or sidewalls 114. The ribbing or tubing 120 can include, but is not limited to, a plastic tubing and a rubber tubing.

Notably, the panels 112, 116 and sidewalls 114 of the primary compartment structure 110 define a first interior space 226 sized and shaped to carry various articles. In this regard, it should be understood that the panels 112, 116 and sidewalls 114 are joined together via a plurality of joinder lines 128, 130, 132, 134. Each of the joinder lines 128, 130, 132, 134 can be formed from a sewn stitching, adhesive bonding and/or heat bonding. If the joinder lines 128, 130, 132, 134 include sewn stitching, then the seams formed From coupling the components 112, 114, 116 together can be water-tight and/or air-tight.

The secondary compartment structures 108, 110 are considered the secondary article-carrying compartment structures because they provide smaller volumes for carrying articles as compared to the main compartment structure 106. If a secondary compartment structure 108, 110 is desired to be used, then one would need to open it via a respective closure element 144, 162 of the secondary compartment structure 108, 110. This configuration is useful for carrying articles which are not to be commingled with articles disposed in the main compartment structure 106, or vice versa. Such articles include, but are not limited to, pens, pencils, calculators, mobile telephone, cellular phones, personal digital assistants, handheld personal computers, sports cloths, sport shoes, towels, wet cloths, and fluid/liquid products.

Accordingly, the secondary compartment structure 108 includes sidewalk 140, 142 defining a second bag opening (not shown in FIGS. 1-2). At least a portion of the sidewall 142 is attached to the hag 100 via a U-shaped closure element 144. The U-shaped closure element 144 provides a means for selectively opening and closing the second bag opening (not shown in FIGS. 1-2). The closure element 144 can include, but is not limited to, a zipper assembly (as shown in FIGS. 1-2), a velcro assembly, loop-and-pile Fasteners, snaps, button/hole pairs and latches. The sidewall 140 is joined to the main compartment structure 106 via at least the joinder line 132. The sidewall 142 is joined to the sidewall 140 via at least one joinder line 160. The joinder lines 132, 160 can he formed from sewn stitching, adhesive bonding and/or heat bonding.

The secondary compartment structure 110 is coupled to secondary compartment structure 108 so as to define a third bag opening (not shown in FIGS. 1-2). The third bag opening (not shown in FIGS. 1-2) is selectively opened and closed using a closure element 162. The closure element 162 can include, but is not limited to, a zipper assembly (as shown in FIGS. 1-2), a velcro assembly, loop-and-pile Fasteners, snaps, button/hole pairs and/or latches.

As noted above, the bag 100 includes an extendable handle 104. The extendable handle 104 can formed from any suitable material. Such materials include, but are not limited to, plastics and metals. The bag 100 can additionally or alternatively include one or more non-extendable handles 170, 172 and a mechanical fastener 174. The non-extendable handles 170, 172 can be formed from any suitable material. Such materials include, but are not limited to, leather, plastic, wood, metal, non-woven fabric, woven fabric, canvas, mesh materials, collapsible fabric materials, a flat rope or a combination thereof. The non-extendable handles 170, 172 are attached to the bag 100 via sewn stitching, adhesive bonding and/or mechanical connectors (e.g., a clip or hook/loop fastener). The mechanical fastener 174 provides a means for attaching objects (e.g., carry-on bags, purses, and backpacks) to the bag 100. In this regard, the mechanical fastener 174 can include, but is not limited to, a buckle and/or a loop, The mechanical fastener 174 is attached to the bag 100 via sewn stitching, an adhesive bond and/or a mechanical connector (e.g., a clip or snap assembly).

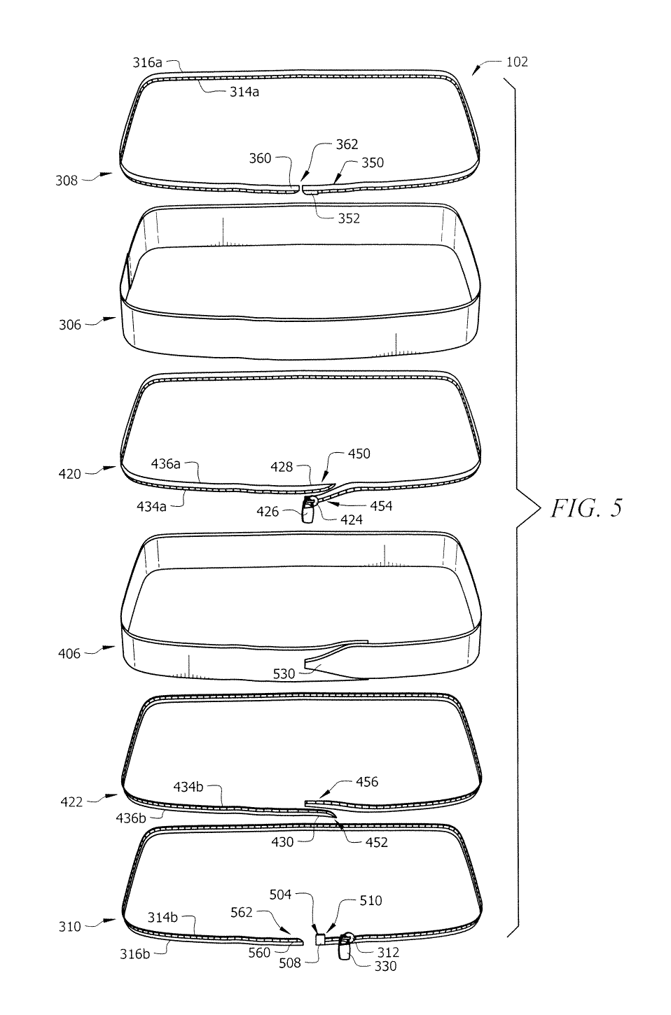

An exemplary embodiment of the multi-stage expandable-contractible system 102 will now be described in detail in relation to FIGS. 3-5. A perspective view of the multi-stage expandable-contractible system 102 in a first stage expanded position is provided in FIG. 3. A perspective view of the multi-stage expandable-contractible system 102 in a second stage expanded position is provided in FIG. 4. An exploded view of the multi-stage expandable-contractible system 102 is provided in FIG. 5.

As noted above, the multi-stage expandable-contractible system 102 is generally configured to facilitate the expansion of the bag 100 so as to provide a compartment structure of a bag with an increased volume for carrying articles. Notably, the multi-stage expandable-contractible system 102 overcomes various drawbacks of conventional multi-stage expandable-contractible systems. For example, the multi-stage expandable-contractible system 102 can be used in two (2) dimensional applications. As such, the multi-stage expandable-contractible system 102 can be integrated along a length of at least one panel 112, 116 or sidewall 114 of the bag 100. Also, the multi-stage expandable-contractible system 102 can be simultaneously placed in a first stage partially expanded position (not shown in FIGS. 1-5) and a second stage partially expanded position (not shown in FIGS. 1-5). The multi-stage expandable-contractible system 102 can further be implemented during a fully automated process. As such, the bag 100 including the multi-stage expandable-contractible system 102 is less expensive to manufacture as compared to a bag comprising conventional multi-stage expandable-contractible systems.

As shown in FIGS. 3-5, the multi-stage expandable-contractible system 102 comprises a plurality of elongated closure elements 302, 304 and a plurality of elongated flexible inserts 306, 406. Notably, when the multi-stage expandable-contractible system 102 is in its contracted position shown in FIGS. 1-2, the closure element 304 is concealed in the bag 100. Consequently, the bag 100 has a more appealing overall appearance when the multi-stage expandable-contractible system 102 is in its contracted position as compared to the appearance of a bag including a conventional multi-stage expandable-contractible system. When the multi-stage expandable-contractible system 102 is in a first stage expanded position shown in FIG. 3, the closure element 304 is visible to an observer as shown in FIG. 4.

Although the closure elements 302, 304 are shown in FIGS. 3-5 to have rectilinear shapes, embodiments of the present invention are not limited in this regard. For example, the closure elements 302, 304 can alternatively have curvilinear shapes or other desirable shapes. Also, the closure elements 302, 304 need not be parallel to one another when the multi-stage expandable-contractible system 102 is in its contracted position and/or expanded position. Alternatively, the closure elements 302, 304 can be perpendicular to each other, diagonal to each other or offset with respect to each other when the multi-stage expandable-contractible system 102 is in its contracted position and/or expanded position. Further, the closure elements 302, 304 can be of the same type or different types of closure elements. For example, both of the closure elements 302, 304 can include a zipper assembly as shown in FIG. 4. Alternatively, at least one of the closure elements 302, 304 can include a velcro closure assembly (not shown). Embodiments of the present invention are not limited in this regard.

Each of the flexible inserts 306, 406 can be formed of any suitable material. Such materials include, but are not limited to, leathers, plastics, non-woven fabrics, woven fabrics, canvases, mesh materials, collapsible fabric materials, flat ropes and combinations thereof. Although the closure elements 302, 304 and flexible inserts 306, 406 are shown in FIGS. 3-4 to extend around the entire periphery of the bag 100, embodiments of the present invention are not limited in this regard. For example, the closure elements 302, 304 and flexible inserts 306, 406 can alternatively extend around a portion of the periphery of the bag 100. In this scenario, the closure elements 302, 304 and flexible inserts 306, 406 can extend along a length of one or more panels 112, 116 or sidewalls 114 of the bag 100.

A first closure element 302 of the plurality of elongated closure elements 302, 304 is generally configured to facilitate the transition of the multi-stage expandable-contractible system 102 from the contracted position shown in FIGS. 1-2 to the first stage fully expanded position shown in FIG. 3 or a first stage intermediary position (not shown), and vise versa.

As such, the first closure element 302 can include, but is not limited to, a zipper assembly (shown in FIGS. 1-5), a velcro assembly, loop-and-pile fasteners, snaps, button/hole pairs and latches.

If the first closure element 302 includes a zipper assembly (as shown in FIGS. 1-5), then it includes a first track 308, a second track 310, at least one actuator 312, at least one actuator pull tab 330, and a plurality of stop mechanisms 360, 560, 504. Each of the tracks 308, 310 includes a plurality of teeth members 314a, 314b coupled to a flexible member 316a, 316b via any suitable means. The teeth members 314a, 314b can be formed of plastic or metal. The flexible members 316a, 316b can be formed from any suitable material. Such materials include, but are not limited to, leathers, tapes, plastics, non-woven fabrics, woven fabrics, canvases, mesh materials, collapsible fabric materials, flat ropes and combinations thereof.

Each of the flexible members 316a, 316b is coupled to the hag 100 via sewn stitching, adhesive bonding and/or heat bonding. For example, a first flexible member 316a is joined to a first portion 318 of the sidewalls 114 of the primary compartment structure 106. Similarly, a second flexible member 316b is joined to a second portion 320 of the sidewalls 114 of the primary compartment structure 106. Notably, the flexible members 316a, 316b are attached to the bag 100 such that the tracks 308, 310 oppose each other in a manner that allows for the interlocking of the respective teeth members 314a, 314b. The teeth members 314a, 314b are interlocked by the displacement of the actuator 312 along the lengths of the tracks 308, 310. The actuator 312 is displaced along the lengths of the tracks 308, 310 by the pulling of the actuator pull tab 330 over the teeth members 314a, 314b.

As noted above, the first closure element 302 includes three (3) stop mechanisms 360, 560, 504. Each of the stop mechanisms 360, 560 is configured to prevent the actuator 312 from traveling past an end 362, 562 of a respective track 308, 310. The stop mechanisms 360, 560 can be formed by bending and attaching the ends 362, 562 of the tracks 308, 310 to the bag 100 so that the actuator 312 is prevented from sliding past the ends 362, 562 of the tracks 308, 310. Alternatively, the stop mechanisms 360, 560 can include, but are not limited to, grommets (not shown in FIGS. 1-5). The stop mechanism 504 is configured to prevent the actuator 312 from traveling past an end 510 of the second track 310. The stop mechanism 504 can include, but is not limited to, a grommet 508 as shown in FIG. 5.

Notably, the end 350 of the first track 308 is absent of a stop mechanism. Instead, the end 350 includes an engagement member 352 sized and shaped for insertion in an aperture (not shown) of the actuator 312. As such, the actuator 312 can travel past the end 350 so as to be disengaged from the first track 308. The actuator 312 can be aligned and re-engaged with the first track 308 by inserting the engagement member 352 in the aperture (not shown) thereof. Consequently, the multi-stage expandable-contractible system 102 can be transitioned from its contracted position shown in FIG. 1 to its first stage fully expanded position shown in FIG. 3 or a first stage intermediary position, and vice versa. In the first stage fully expanded position, the flexible insert 306 is unfolded so as to extend between the front panel 112 and sidewalls 114 of the primary compartment structure 106 of the bag 100. Accordingly, the bag 100 has a width W₁ as shown in FIG. 3. The width W₁ is greater than the width W₀ of the bag 100 (shown in FIG. 1) when the multi-stage expandable-contractible system 102 is in its fully contracted position (shown in FIG. 1). In the contracted position, the flexible insert 306 is folded and housed in the primary compartment structure 106 of the hag 100.

A second closure element 304 of the plurality of elongated closure elements 302, 304 is generally configured to facilitate the transition of the multi-stage expandable-contractible system 102 from a contracted position (shown in FIGS. 1-2) to a second stage fully expanded position (shown in FIG. 4) or a first stage intermediary position (not shown), and vise versa. In the contracted position, the flexible insert 406 is folded and housed in the primary compartment structure 106 of the hag 100. In the first stage fully expanded position, the flexible insert 406 is unfolded so as to extend between the flexible insert 306 of the multi-stage expandable-contractible system 102 and the sidewalls 114 of the primary compartment structure 106 of the bag 100. Accordingly, the bag 100 has a width W₂ as shown in FIG. 4. The width W₂ is greater than the width W₀ of the bag 100 (shown in FIG. 1) when the multi-stage expandable-contractible system 102 is in its fully contracted position (shown in FIG. 1). Similarly, the width W₂ is greater than the width W₁ of the hag 100 (shown in FIG. 3) when the multi-stage expandable-contractible system 102 is in its first stage expanded position (shown in FIG. 3).

The second closure element 304 can include, but is not limited to, a zipper assembly (shown in FIGS. 1-5), a velcro assembly, loop-and-pile fasteners, snaps, button/hole pairs and latches. If the second closure element 304 includes a zipper assembly (as shown in FIGS. 1-5), then it includes a First track 420, a second track 422, at least one actuator 424, at least one actuator pull tab 426, and a plurality of stop mechanisms 428, 430, 432. Each of the tracks 420, 422 includes a plurality of teeth members 434a, 434b coupled to a flexible member 436a, 436b via any suitable means. The teeth members 434a, 434b can be formed of plastic or metal. The flexible members 436a, 436b can be formed from any suitable material. Such materials include, but are not limited to, leathers, tapes, plastics, non-woven fabrics, woven fabrics, canvases, mesh materials, collapsible fabric materials, flat ropes and combinations thereof.

Each of the flexible members 436a, 436b is coupled to the bag 100 via sewn stitching, adhesive bonding, and/or heat bonding. For example, a first flexible member 436a is joined to the flexible insert 306 of the multi-stage expandable-contractible system 102. Similarly, the second flexible member 436b is joined to portion 320 of the side panel 114 of the primary compartment structure 106 (not shown in FIGS. 1-2). Notably, the flexible members 436a, 436b are attached to the bag 100 such that the tracks 420, 422 oppose each other in a manner that allows for the interlocking of the respective teeth members 434a, 434b. The teeth members 434a, 434b are interlocked by the displacement of the actuator 424 along the lengths of the tracks 420, 422. The actuator 424 is displaced along the lengths of the tracks 420, 422 by the pulling of the actuator pull tab 426 over the teeth members 434a, 434b.

As noted above, the second closure element 304 includes a plurality of stop mechanisms 428, 430, 432. Although the stop mechanism 428, 430 are shown in FIG. 4 to be offset relative to the stop mechanisms 360, 560 of the first closure element 302, embodiments of the present invention are not limited in this regard. For example, the stop mechanisms 428, 430 can be longitudinally aligned with the stop mechanisms 360, 560 of the first closure element 302.

Notably, the stop mechanisms 428, 430, 432 of the second closure element 304 are configured to prevent the actuator 424 from being fully disengaged from the tracks 420, 422. In this regard, it should be appreciated that the stop mechanism 428 is configured to prevent the actuator 424 from traveling past an end 450 of the first track 420. The stop mechanism 430 is configured to prevent the actuator 424 from traveling past an end 452 of the second track 422. The stop mechanism 432 is configured to prevent the actuator 424 from traveling past ends 454 of the first track 420 and end 456 of the second track 422.

As shown in FIG. 4, the stop mechanism 428 is formed by bending and attaching the end 450 of the first track 420 to the bag 100 so that the actuator 424 is prevented from sliding past the end 450 of the first track 420. Similarly, the stop mechanism 430 is formed by bending and attaching the end 452 of the second track 422 to the bag 100 so that the actuator 424 is prevented from sliding past the end 452 of the second track 452. The stop mechanism 432 is formed by joining the respective ends 454, 456 of the tracks 420, 422 together and/or joining the ends 454, 456 of the tracks 420, 422 to a v-shaped end 530 of the flexible insert 406. Embodiments of the present invention are not limited in this regard. For example, the stop mechanisms 428, 430, 432 can alternatively include, but are not limited to, grommets (not shown in FIGS. 1-5).

As shown in FIG. 4, the first track 420 of the second closure element 304 is shown to reside a distance D from the first track 308 of the first closure element 302. The second track 422 of the second closure element 304 are shown to be adjacent to the second track 310 of the first closure element 302. Embodiments of the present invention are not limited in this regard. For example, the first track 420 can reside a distance D′ from the first track 308 of the first closure element 302. The distance D′ can be greater than or less than the distance D shown in FIG. 4. Also, the second track 422 of the second closure element 304 can reside a distance D″ (not shown) from the second track 310 of the first closure element 302. The distance D″ (not shown) can be selected in accordance with a particular application. For example, the distance D″ (not shown) can be equal to, greater than or less than the distance D (shown in FIG. 4) or D′ (not shown).

As also shown in FIG. 4, the first and second closure elements 302, 304 are opened and closed by displacing the actuators 312, 424 in the same directions along the respective tracks 308, 310, 420, 422. Embodiments of the present invention are not limited in this regard. For example, the first and second closure elements 302, 304 can alternatively be opened and closed by displacing the actuators 312, 424 in different directions along the respective tracks 308, 310, 420, 422. The different directions can include, but are not limited to, opposing directions, orthogonal directions, and other directions that are at angles with respect to each other.

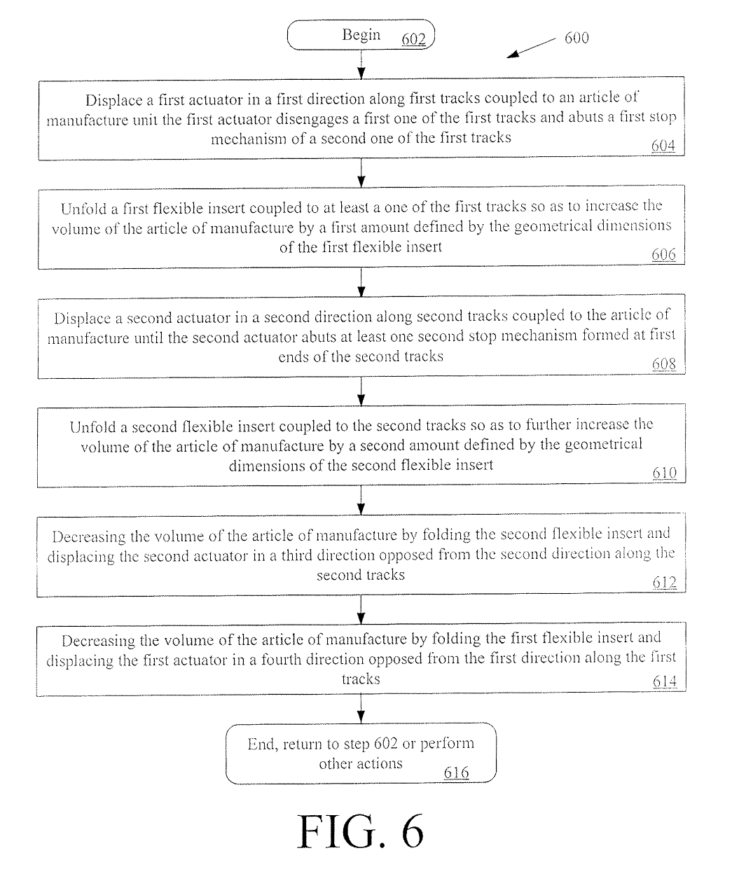

Referring now to FIG. 6, there is provided a flow diagram of a method 600 for adjusting a volume of an article of manufacture (e.g., bag 100) that is useful for understanding the present invention. As shown in FIG. 6, the method 600 begins with step 602 and continues with step 604. In step 604, a first actuator (e.g., actuator 312 of FIG. 3) is displaced in a first direction along first tracks (e.g., tracks 308, 310 of FIG. 3). The first actuator is coupled to the article of manufacture. The first actuator can be displaced along the first tracks until it disengages one of the first tracks (e.g., track 308 of FIG. 3) and abuts a first stop mechanism (e.g., stop mechanism 504 of FIG. 5) formed at an end (e.g., end 510 of FIG. 5) of a second one of the first tracks (e.g., track 310 of FIG. 3). The first stop mechanism can be formed by attaching a grommet to the end of a second one of the first tracks.

After completing step 604, step 606 is performed where a first flexible insert (e.g., flexible insert 306 of FIG. 3) is unfolded. As a consequence of this unfolding, the volume of the article of manufacture is increased by a first amount. The first amount can be defined by the geometrical dimensions of the first flexible insert.

In a next step 608, a second actuator (e.g., actuator 424 of FIG. 4) is displaced in a second direction along second tracks (e.g., tracks 420, 422 of FIG. 4). The second tracks are coupled to the article of manufacture. The second direction can be the same as or different than the first direction. The second actuator can be displaced along the second tracks until it abuts at least one second stop mechanism (e.g., stop mechanism 432 of FIG. 4) formed at ends (e.g., ends 454 of FIG. 4) of the second tracks. The second stop mechanism can be formed by joining the ends of the second tracks together.

Upon completing step 608, the method 600 continues with step 610. In step 610, a second flexible insert (e.g., flexible insert 406 of FIG. 4) is unfolded. As a consequence of this unfolding, the volume of the article of manufacture is further increased by a second amount. The second amount can be the same as, greater than or less than the first amount. The second amount can be define by the geometrical dimensions of the second flexible insert.

The volume of the article of manufacture can be decreased by performing at least one of the steps 612 and 614. In step 612, the volume of the article of manufacture is decreased by: folding the second flexible insert; and/or displacing the second actuator in a third direction along the second tracks. The third direction is opposed from the second direction. The second actuator can be displaced along the second tracks until it abuts stop mechanisms (e.g., stop mechanisms 428, 430 of FIG. 4) formed at second ends (e.g., ends 450, 452 of FIG. 4) of the second tracks. The stop mechanisms can be formed at least partially by bending the second ends of the second tracks or attaching grommets to the second ends of the second tracks.

In step 614, the volume of the article of manufacture is decreased by: folding the first flexible insert; and/or displacing the first actuator in a fourth direction along the first tracks. The fourth direction is opposed from the first direction. The first actuator can be displaced along the first tracks until it abuts stop mechanisms e.g., stop mechanism 360 of FIG. 3 and stop mechanism 560 of FIG. 5) formed at second ends (e.g., end 362 of FIG. 3 and end 562 of FIG. 5) of the first tracks. The stop mechanisms can be formed at least partially by bending the second ends of the first tracks or attaching grommets to the second ends of the first tracks. Subsequent to completing step 614, step 616 is performed where the method 600 ends, returns to step 602 or continues with the performance of other actions.

The word “exemplary” is used herein to mean serving as an example, instance or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept. spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for adjusting a volume of an article of manufacture having an expandable-contractible system, comprising:
displacing a first actuator in a first direction along at least two first tracks coupled to said article of manufacture until said first actuator disengages a first one of said first tracks and abuts a first stop mechanism formed at a first end of a second one of said first tracks;
unfolding a first flexible insert coupled to said first one of said first tracks so as to adjust said volume of said article of manufacture by a first amount defined by geometrical dimensions of said first flexible insert;
displacing a second actuator in a second direction along at least two second tracks coupled to said article of manufacture until said second actuator abuts at least one second stop mechanism formed at first ends of said second tracks; and
unfolding a second flexible insert coupled to said second tracks so as to further adjust said volume of said article of manufacture by a second amount defined by geometrical dimensions of said second flexible insert.

2. The method according to claim 1, further comprising concealing said second actuator and said two second tracks in said article of manufacture when said expandable-contractible system is not in use.

3. The method according to claim 1, further comprising selecting said first direction to be the same as said second direction.

4. The method according to claim 1, further comprising selecting said first direction to he different than said second direction.

5. The method according to claim 1, further comprising forming said first stop mechanism by attaching a grommet to said first end of said second one of said first tracks.

6. The method according to claim 1, further comprising forming said second stop mechanism by joining said first ends of said second tracks together.

7. The method according to claim 1, further comprising selecting said first amount to be greater than, equal to or less than said second amount.

8. The method according to claim 1, further comprising decreasing said volume of said article of manufacture by folding said first flexible insert and displacing said first actuator in a third direction opposed from said first direction along said first tracks.

9. The method according to claim 8, wherein said first actuator is displaced in said third direction until said first actuator abuts a third stop mechanism formed at a second end of said first one of said first tracks and abuts a fourth stop mechanism formed at a second end of said second one of said first tracks.

10. The method according to claim 9, further comprising forming said third and fourth stop mechanisms by bending said second ends of said first tracks.

11. The method according to claim 9, further comprising forming each of said third and fourth stop mechanisms by attaching a grommet to said second end of a respective one of said first tracks.

12. The method according to claim 1, further comprising decreasing said volume of said article of manufacture by folding said second flexible insert and displacing said second actuator in a third direction opposed from said second direction along said second tracks.

13. The method according to claim 12, wherein said second actuator is displaced in said third direction until said second actuator abuts a third stop mechanism formed at a second end of said first one of said second tracks and abuts a fourth stop mechanism formed at a second end of said second one of said second tracks.

14. The method according to claim 13, further comprising forming said third and fourth stop mechanisms by bending said second ends of said second tracks.

15. The method according to claim 13, further comprising forming each of said third and fourth stop mechanisms by attaching a grommet to said second end of a respective one of said second tracks.

16. The method according to claim 1, further comprising selecting at least one of said first tracks and said second tracks to have a rectilinear shape or a curvilinear shape.

17. An expandable-contractible system for adjusting an overall size of an article of manufacture, comprising:
at least two first tracks having non-spiral shapes;
at least two second tracks having non-spiral shapes and disposed in said expandable-contractible system so as to be concealed at least partially by said first tracks when said expandable-contractible system is not in use;
a first actuator configured for being displaced in a first direction along said first tracks and for being disengaged from a first one of said first tracks;
a first flexible insert coupled to said first one of said first tracks and configured to be transitioned from a folded position to an unfolded position in which said overall size of said article of manufacture is increased by a first amount defined by geometrical dimensions of said first flexible insert;
a second actuator coupled to said second tracks and configured for being displaced in a second direction along said second tracks; and
a second flexible insert coupled to said second tracks and configured to be transitioned from a folded position to an unfolded position in which said overall size of said article of manufacture is increased by a second amount defined by geometrical dimensions of said second flexible insert.

18. The expandable-contractible system according to claim 17, wherein said first direction is the same as said second direction.

19. The expandable-contractible system according to claim 17. wherein said first direction is different than said second direction.

20. The expandable-contractible system according to claim 17, further comprising a stop mechanism formed at least one end of each of said first and second tracks.

21. The expandable-contractible system according to claim 20. wherein said stop mechanism comprises a grommet.

22. The expandable-contractible system according to claim 20, wherein said stop mechanism is formed by bending said end.

23. The expandable-contractible system according to claim 20, wherein said stop mechanism is formed by joining said ends of said second tracks together.

24. The expandable-contractible system according to claim 17, wherein said first amount is greater than, equal to or less than said second amount.

25. An expandable-contractible system for adjusting an overall size of an article of manufacture, comprising:
(a) a first closure element of a first type of closure element, said including
(i) at least two first tracks having non-spiral shapes,
(ii) a first actuator configured for being displaced in a first direction along said first tracks and for being disengaged from a first one of said first tracks, and
(iii) a first flexible insert coupled to said first one of said first tracks and configured to be transitioned from a folded position to an unfolded position in which said overall size of said article of manufacture is increased by a first amount defined by geometrical dimensions of said first flexible insert; and
(b) a second closure element of a second type of closure element, said second closure element disposed in said expandable-contractible system so as to be concealed at least partially by said first closure element when said expandable-contractible system is not in use;
wherein said first type of closure element is different from said second type of closure element.

26. The expandable-contractible system according to claim 25, wherein said second type of closure element is selected from the group consisting of a velcro closure element, a loop-and-pile fastener assembly, a snap assembly, a button/hole pair e assembly and a latch assembly.

27. A bag, comprising:
(a) at least one compartment structure defining an interior space for carrying articles; and
(b) an expandable-contractible system configured for adjusting a size of said interior space, said expandable-contractible system comprising
(i) at least two first tracks having non-spiral shapes,
(ii) at least two second tracks having non-spiral shapes and disposed in said expandable-contractible system so as to be concealed at least partially by said first tracks when said expandable-contractible system is not in use,
(iii) a first actuator configured for being displaced in a first direction along said first tracks and for being disengaged from a first one of said first tracks,
(iv) a first flexible insert coupled to said first one of said first tracks and configured to be transitioned from a folded position to an unfolded position in which said size of said interior space is increased by a first amount defined by geometrical dimensions of said first flexible insert,
(v) a second actuator coupled to said second tracks and configured for being displaced in a second direction along said second tracks, and
(vi) a second flexible insert coupled to said second tracks and configured to be transitioned from a folded position to an unfolded position in which said size of said interior space is increased by a second amount defined by geometrical dimensions of said second flexible insert.

28. The bag according o claim 27, wherein said first direction is the same as said second direction.

29. The bag according to claim 27, wherein said first direction is different than said second direction.

30. The hag according to claim 27, further comprising a stop mechanism formed at at least one end of each of said first and second tracks.

31. The bag according to claim 30, wherein said stop mechanism comprises a grommet.

32. The bag according to claim 30, wherein said stop mechanism is formed by bending said end.

33. The bag according to claim 30, wherein said stop mechanism is formed by joining said ends of said second tracks together.

34. The bag according o claim 27, wherein said first amount is greater than, equal to or less than said second amount.

35. A bag, comprising:
(A) at least one compartment structure defining an interior space for carrying articles; and
(B) an expandable-contractible system for adjusting an overall size of said interior space, comprising:
(a) a first closure element of a first type of closure element, said including
(i) at least two first tracks having non-spiral shapes,
(ii) a first actuator configured for being displaced in a first direction along said first tracks and for being disengaged from a first one of said first tracks, and
(iii) a first flexible insert coupled to said first one of said first tracks and configured to be transitioned from a folded position to an unfolded position in which said overall size of said bag is increased by a first amount defined by geometrical dimensions of said first flexible insert; and
(b) a second closure element of a second type of closure element, said second closure element disposed in said expandable-contractible system so as to be concealed at least partially by said first closure element when said expandable-contractible system is not in use;
wherein said first type of closure element is different from said second type of closure element.

36. The bag according to claim 35, wherein said second type of closure element is selected from the group consisting of a velcro closure element, a loop-and-pile fastener assembly, a snap assembly, a button/hole pair e assembly and a latch assembly.
